(19) United States
(12) Patent Application Publication
(10) Pub. No.: US 2023/0194739 A1
(43) Pub. Date: Jun. 22, 2023

(54) SUBSEA SURVEY METHODS AND RELATED SYSTEMS

(71) Applicant: Delta SubSea LLC, Montgomery, TX (US)

(72) Inventors: Scott Paul Dingman, Montgomery, TX (US); Brandon Broom, Montgomery, TX (US)

(21) Appl. No.: 18/086,133

(22) Filed: Dec. 21, 2022

Related U.S. Application Data
(60) Provisional application No. 63/292,951, filed on Dec. 22, 2021.

(51) Int. Cl. G01V 1/30; G01V 1/34; G01V 1/38; G01S 15/89; G01V 3/02

(52) U.S. Cl. CPC G01V 1/307; G01S 15/89; G01V 1/345; G01V 1/3808; G01V 1/3843; G01V 3/02; G01V 2210/74

(57) ABSTRACT

Systems and methods for surveying a seafloor utilize two or more of seismic data, acoustic data and electrical potential or resistivity data to identify the locations of objects on or beneath the seafloor. The methods involve moving survey equipment over a geographic area of the seafloor and conducting a plurality of sensing or detecting operations while moving the survey equipment over the geographic area. The plurality of operations include two or more of: (1) a seismic operation that emits seismic energy toward the seafloor and collects seismic data based on seismic energy that returns from the seafloor, (2) an acoustic operation that emits acoustic energy toward the seafloor and collects acoustic data based on acoustic energy that returns from the seafloor, and/or (3) an electrical operation that supplies electrical power into seawater and that collects electric potential data indicative of electric potential that is induced into the seawater.

This application claims priority to the Dec. 22, 2021 filing date of U.S. Provisional Pat. Application No. 63/292,951, the entire contents of which are incorporated herein by reference.

### FIELD OF THE DISCLOSURE

The present disclosure relates to subsea survey methods and related systems. In one aspect, a method is used to locate pipe buried below a seafloor.

### BRIEF DESCRIPTION OF THE DRAWINGS

The accompanying drawings are part of the present disclosure and are incorporated into the specification. The drawings illustrate examples of embodiments of the disclosure and, in conjunction with the description and claims, serve to explain various principles, features, or aspects of the disclosure. Certain embodiments of the disclosure are described more fully below with reference to the accompanying drawings. However, various aspects of the disclosure may be implemented in many different forms and should not be construed as being limited to the example embodiments set forth herein.

FIG. 1 is a schematic side view of a subsea survey system, according to an exemplary implementation.

FIG. 2 is a schematic partial top view that shows a seismic subsystem of the subsea survey system shown in FIG. 1.

FIG. 3 shows a two-dimensional image of a seafloor, according to an exemplary implementation, that can be generated using methods described herein.

FIG. 4 shows an isometric view of the seafloor shown in FIG. 3 that can be generated using methods described herein.

FIG. 5A shows specular reflection of seismic energy.

FIG. 5B shows reflection of seismic energy that includes diffracted seismic energy.

FIG. 6 is a flow diagram of a method of surveying a seafloor, according to an exemplary implementation.

In the appended drawings, reference numbers that appear in more than one figure refer to the same structural feature. The drawings depict at least one example of each implementation, embodiment, or aspect to illustrate the features of the present disclosure and are not to be construed as limiting the disclosure thereto. It is contemplated that aspects, features, operations, components, elements, and/or properties in one implementation may be beneficially used in other implementations without specific recitation.

### DETAILED DESCRIPTION

The present disclosure relates to subsea survey methods and related systems. Subsea surveying can be used to survey seafloors and detect items that are on the seafloor or buried beneath the seafloor.

As an example, pipe can be buried beneath the seafloor for use in relation to oil and gas operations. For example, wellhead conductors can be buried beneath the seafloor for use in oil and gas production. It can be desirable to access the buried pipe to conduct intervention or maintenance operations, and the seafloor may need to be excavated to access the buried pipe.

Reliability of measurements is limited for current operations that are used to detect buried pipe. For example, certain operations that are configured to detect objects that are less than 100 feet below the seafloor can fail to accurately locate pipe that is buried more 100 feet below the seafloor. Additionally, other operations that are configured to detect objects that are more than 100 feet below the seafloor can fail to accurately locate pipe that is buried less than 100 feet below the seafloor. The reliability problems associated with object depths of buried pipe are exacerbated by variations in floor depths of the seafloor relative to a seawater surface. That is, variations in the floor depth of the seafloor relative to the seawater surface can also affect the reliability of measurements.

The problems with reliability can hinder operations that seek to access the buried pipe. For example, an inability to determine the specific location of a buried pipe within a particular area can result in excavation of more seafloor than is actually needed to access the buried pipe. Unnecessary excavation can result in increased expenditure of resources, increased costs, and increased operational delays. Reliability is particularly problematic when operators only seek to access particular sections of pipe, such as well conductor sections of the pipe.

The present disclosure provides subsea survey methods and related systems that facilitate enhanced reliability for detecting and locating objects buried beneath the seafloor. In one exemplary embodiment, a method of surveying a seafloor includes moving survey equipment over a geographic area of the seafloor and simultaneously conducting a plurality of detecting or sensing operations. The plurality of operations may include: (1) a seismic operation that emits seismic energy toward the seafloor and that collects data regarding seismic energy that is reflected back from the seafloor; (2) an acoustic operation that emits acoustic energy toward the seafloor and that collects data regarding acoustic energy that is reflected back from the seafloor; and/or (3) an electrical operation that supplies electrical current into seawater and that collects data regarding electric potential that is induced into the seawater. In some embodiments, using two or more of the seismic operation, the acoustic operation, and/or the electrical operation can facilitate reliably locating pipe buried at a variety of object depths below the seafloor and at a variety of floor depths of the seafloor relative to the surface of the seawater.

In one aspect, the method includes identifying a location of a pipe buried below the seafloor and identifying a subarea of the geographic area for accessing the pipe. The subarea can be used, for example, to reduce expenditures of resources and time in accessing the pipe. As an example, a size of a cofferdam used to excavate the seafloor can be reduced to tailor the cofferdam to the subarea. The present disclosure contemplates that aspects disclosed herein can be used to locate objects other than buried pipe, such as ship wreckage.

Exemplary implementations of the present disclosure provide numerous benefits. The benefits include reliably locating objects buried beneath the seafloor, increased accuracy in surveying at varying object depths and floor depths, and less complex operations for accessing buried objects. These aspects result in benefits that include reduced expenditures of resources, reduced costs, and reduced operational times.

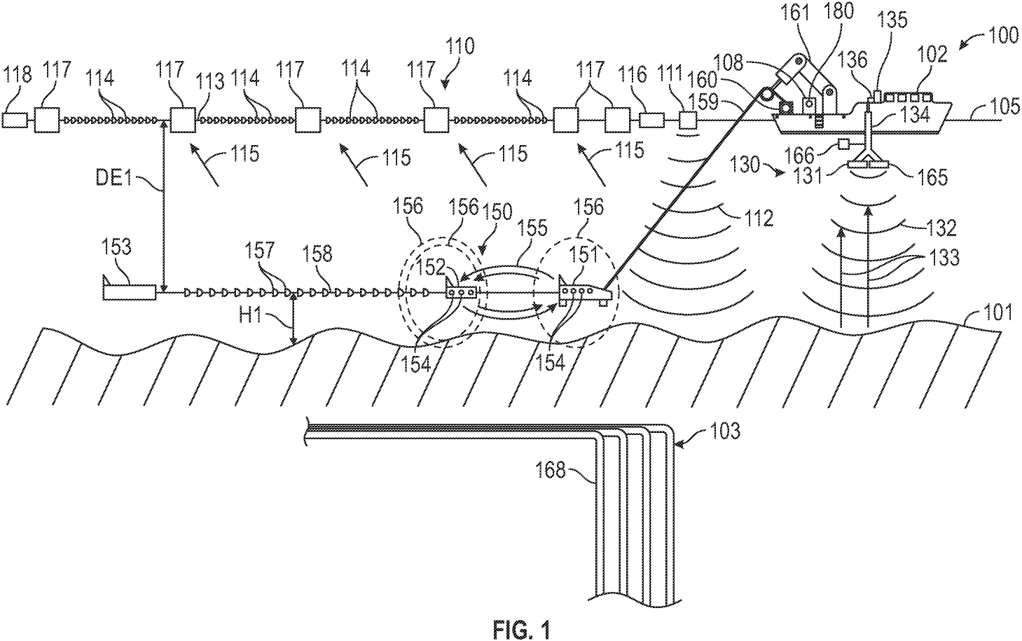

FIG. 1 is a side view of a subsea survey system 100, according to an exemplary implementation. The system 100 is configured to survey a seafloor 101.

The system 100 includes survey equipment in the form of a seismic subsystem 110, an acoustic subsystem 130, and an electrical subsystem 150. The system 100 is attached to a vessel 102 that moves survey equipment over a geographic area of the seafloor 101. The system 100 is configured to conduct two or more of a seismic operation, an acoustic operation, and/or an electrical operation while the survey equipment moves across the geographic area of the seafloor 101. In the depiction in FIG. 1, the geographic area of the seafloor 101 spans areas where one or more objects 103 are buried beneath the seafloor 101. The system 100 can also be configured to conduct a mapping operation, as discussed below. In some embodiments, the system 100 also can be configured to conduct a magnetic operation that collects magnetic data using a magnetometer.

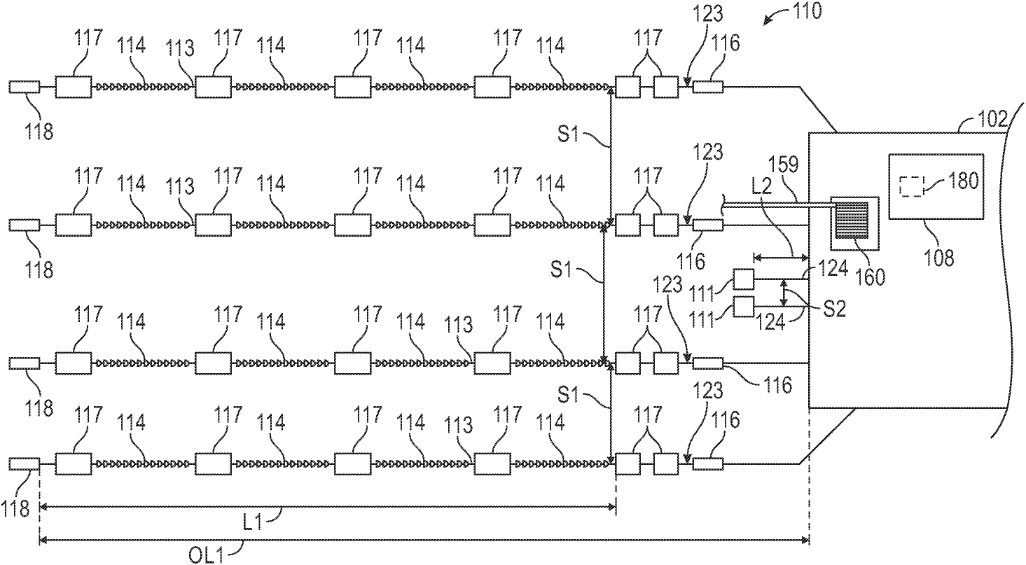

The seismic subsystem 110 includes one or more sparker units 111 towed by the vessel 102. Each sparker unit 111 includes a plurality of sparker electrodes configured to emit seismic energy 112 (e.g., pressure waves) toward the seafloor 101. As illustrated in FIG. 2, the seismic subsystem 110 includes a plurality of seismic cables 113 towed by the vessel 102 and located behind the sparker units 111. The seismic subsystem 110 includes a plurality of seismic receivers 114 disposed along each of the seismic cables 113 and configured to receive reflected seismic energy 115 that reflects from the seafloor 101. Each seismic cable 113 includes a lead GPS float 116 located behind the sparker units 111, compass birds 117 towed behind the lead GPS float 116 and spaced along the seismic cable 113, and a tail GPS float 118 towed behind the compass birds 117. The seismic receivers 114 are disposed between respective compass birds 117.

Each of the sparker units 111, the seismic cables 113, the seismic receivers 114, the GPS floats 116, 118, and the compass birds 117 are preferably towed within a depth of 5 meters or less relative to a surface 105 of the seawater. Each of the sparker units 111, the seismic cables 113, the seismic receivers 114, the GPS floats 116, 118, and the compass birds 117 can be towed at the surface 105, as shown in FIG. 1.

As part of the seismic operation, the seismic subsystem 110 collects seismic data based on of the seismic energy 115 received by the seismic receivers 114. The emitted seismic energy 112 and the reflected seismic energy 115 are preferably respectively emitted and received at frequencies of between approximately 300 Hz and approximately 1,200 Hz. In some embodiments, the seismic data may be collected in temporal sampling intervals within a range of approximately 0.2 milliseconds to approximately 0.3 milliseconds (such as 0.25 milliseconds), and a slice duration in a range of approximately 0.5 seconds to approximately 0.7 seconds (such as 0.6 seconds). The seismic receivers 114 are configured to receive both reflected and diffracted seismic energy such that the collected seismic data is indicative of both reflected and diffracted seismic energy. As an example, the seismic energy 112 emitted toward the seafloor 101 can diffract (rather than simply reflecting at a specular angle) upon encountering one or more buried objects 103 such that the seismic energy 115 detected by the seismic receivers 114 includes diffracted seismic energy.

The acoustic subsystem 130 includes an acoustic transducer 131 mounted to or positioned below the vessel 102 and extending into the seawater. The acoustic transducer 131 is configured to emit acoustic energy 132 toward the seafloor 101 and to receive reflected acoustic energy 133 that reflects from the seafloor 101. The acoustic transducer 131 may be mounted directly to the vessel 102, or the acoustic transducer 131 may be mounted to the vessel 102 using a pole 134 that is pivotably coupled to the vessel 102. The acoustic transducer 131 is connected to a transceiver 135 mounted to the vessel 102 at a location above the surface 105 of the seawater. The acoustic transducer 131 may be connected to the transceiver 135 using a cable 136 or via a short-range wireless connection.

As part of the acoustic operation, the acoustic subsystem 130 collects acoustic data based on the reflected acoustic energy 133 detected by the acoustic transducer 131 and based on a signal sent from the acoustic transducer 131 to the transceiver 135. The acoustic frequency is different from the seismic frequency

In some embodiments, the system 100 can include a scanner 165 mounted to the pole 134 and configured to scan the seafloor 101 to collect map data regarding the seafloor 101. The system 100 can collect the map data as part of an optional mapping operation. The scanner 165 can be, for example, a multibeam echosounder. The system 100 also can include a tracker 166 that is configured to track the positions and movements of the components of the electrical subsystem 150.

The electrical subsystem 150 includes a first electrode housing 151 towed by the vessel 102 and a second electrode housing 152 towed behind the first electrode housing 151. The first electrode housing 151 is towed using a line 159 that is paid in and out of a winch 160 of the vessel 102. The line 159 may be supported using a crane 161 of the vessel 102.

A sensor housing 153 is towed behind the second electrode housing 152. The electrical subsystem 150 further includes a plurality of transmitter electrodes 154 on the first and second electrode housings 151/152 that are configured to supply electrical power 155 into the seawater. The first electrode housing 151 can include control electronics. The electrical power 155 induces electric potential into the seawater, as depicted by the dashed lines 156 in FIG. 1. The electrical subsystem 150 includes a plurality of receiver electrodes 157 disposed along a receiver cable 158 that is towed behind the second electrode housing 152. Each receiver electrode 157 is configured to detect electric potential in the surrounding area. The receiver cable 158 can be a part of the line 159.

Each of the electrode housings 151, 152 (having the transmitter electrodes 154), the receiver electrodes 157, and the sensor housing 153 are towed at a height H1 above the seafloor 101. The height H1 is preferably 10 meters or less. In one or more embodiments, the height H1 is in a range of 4.5 meters to 5.5 meters, such as 5.0 meters. In one or more embodiments, the electrical power 155 is pulsed into the seawater at a pulse interval. In some embodiments the pulse interval is in a range of approximately 0.4 seconds to approximately 0.6 seconds, such as 0.5 seconds. In some embodiments the electrical power 155 is supplied into the seawater at less than approximately 100 Amps, such as 40 Amps. In some embodiments the electrical power 155 is supplied into the seawater at less than approximately 40 Volts, such as 12 Volts.

As part of the electrical operation, the electrical subsystem 150 collects electric potential data using the receiver electrodes 157. The electric potential data is a function of a resistivity of the seawater at the height H1 above the seafloor 101 (and a corresponding depth DE1 below the seawater surface 105). Also, the electrical potential detected by each receiver electrode 157 is a function of the distance between the receiver electrode 157 and the transmitter electrodes 154. Hence, the electrical operation can be referred to as a resistivity detection operation. The sensor housing 153 includes sensors configured to detect the height H1 and/or the depth DE1. The electric potential data collected by the receiver electrodes 157 can be used to generate electric resistivity data.

The system 100 is configured to conduct two or more of a seismic operation, an acoustic operation, and/or an electrical operation, either simultaneously or sequentially. As an example, a single vessel 102 having two or more of the subsystems 110, 130, 150 can simultaneously conduct two or more of the operations. Alternatively, a single vessel 102 having two or more of the subsystems 110, 130, 150 can sequentially conduct two or more of the operations, such as in sequential runs over the same geographic area. As another example, two or more of the subsystems 110, 130, 150 can be spread out among two or more vessels that are configured to conduct two or more of the operations either simultaneously or sequentially.

The collected seismic data, the collected acoustic data, and/or the collected electric potential data are transmitted to a central controller 180 in a wired or wireless manner. Map data collected using the scanner 165 can also be transmitted to the central controller 180. The central controller 180 can be located in a survey room 108 of the vessel 102, or the central controller 180 could be located remotely, such as part of a cloud computing system. The central controller 180 processes two or more of the seismic data, the acoustic data, and/or the electric potential data, and extracts data points that indicate the presence one or more objects 103 buried in the seafloor 101. Each of the seismic data, the acoustic data, and/or the electric potential data can be represented as a wave, and the data points can be extracted by identifying peaks of each wave. In one or more embodiments, the central controller 180 uses the electric potential data to generate electric resistivity data, and the electric resistivity data can be represented as a wave from which data points are extracted.

The one or more buried objects 103 can be, for example, pipe used in oil and gas operations. The seismic data, the acoustic data, and/or the electric potential data (which can be used to generate electric resistivity data) exhibit notable features that were measured or obtained at specific corresponding geographic locations. The central controller 180 generates an image of the seafloor 101 and plots the extracted data points in the image using the geographic locations at which the notable measurement features were obtained. The image can be three-dimensional or two-dimensional. The image can be generated using the mapping data to show features of the seafloor 101. The plotted data points indicate one or more geographic locations of the one or more buried objects 103 in the image. The image can be displayed on a display, such as a display in the survey room 108 of the vessel 102.

The central controller 180 can involve any suitable processing devices. The central controller 180 can include one or more processors, memories, and support circuitry. The one or more processors can execute software that is stored in a memory. The software, when executed, can cause the operations described herein to be conducted. The central controller 180 can also communicate with other processors of the system 100. The memory may include any memory or database module and may take the form of volatile or non-volatile memory including but not limited to magnetic media, optical media, random access memory (RAM), read-only memory (ROM), removable media, or any other suitable local or remote memory component. The memory can be any suitable non-transitory computer readable medium.

FIG. 2 is a partial top view that shows the layout of an example seismic subsystem 110 of the subsea survey system 100 shown in FIG. 1. Each seismic cable 113 (four are shown) can be a part of a seismic line 123 towed by the vessel 102. In some embodiments a first length L1 of each seismic cable 113 preferably is less than 300 meters, such as 200 meters. In some embodiments an overall length OL1 of each seismic line 123 preferably is less than 500 meters, such as 300 meters. The seismic cables 113 are spaced from each other by a first spacing S1 that can be 10 meters or less, such as 6.25 meters. Each seismic cable 113 can as many as 50 or more seismic receivers 114, such as 64 seismic receivers 114.

Each sparker unit 111 is towed by a sparker line 124. Each sparker line 124 has a second length L2 that may be 50 meters or less, such as 25 meters. The sparker lines 124 are spaced from each other by a second spacing S2 that may be 5 meters or less, such as 3.125 meters.

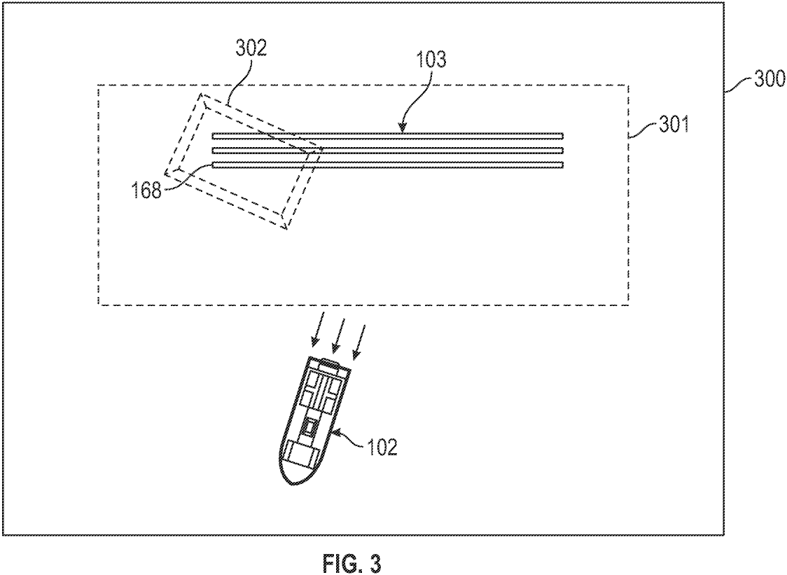

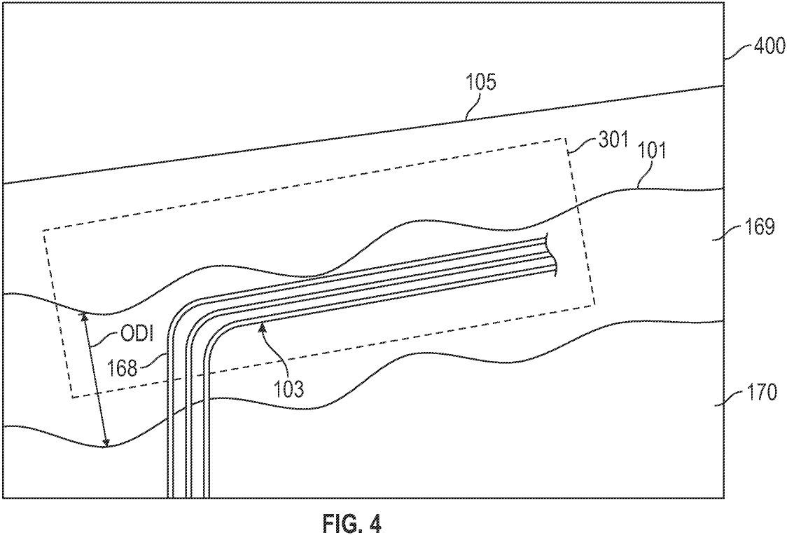

FIG. 3 shows a two-dimensional image 300 of a top view of the seafloor 101, according to an exemplary implementation, that can be generated using methods described herein. FIG. 4 shows an isometric image 400 of the seafloor 101 shown in FIG. 3 that can be generated using methods described herein. As shown in FIG. 3, the vessel 102 has moved survey equipment over a geographic area 301 of the seafloor 101 while conducting two or more of the seismic operation, the acoustic operation, and/or the electrical operation. Extracted data points are plotted in the images 300, 400 to show the locations of the buried objects 103. The three-dimensional image 400 in FIG. 4 shows well conductor sections 168 of the buried objects 103. Using the two-dimensional image 300 and/or the three-dimensional image 400, operations personnel (such as personnel in the survey room 108) can identify a subarea 302 of the geographic area 301 for accessing the one or more buried objects 103. As an example, the subarea 302 can be identified to provide access to the portions of the well conductor sections 168 that extend downward into the seafloor 101 while excluding other sections of the well conductor sections 168 that extend at substantially the same depth just under the seafloor 101. As an example, a cofferdam can be designed to encompass the subarea 302 while excluding other sections of the geographic area 301. The cofferdam can be designed to have a footprint similar to the footprint of the subarea 302. The cofferdam can be similar to the cofferdam implementations disclosed in U.S. Pat. No. 10,947, 692 and/or the cofferdam implementations disclosed in U.S. Pat. Application Serial No. 17/490,719, each of which is hereby incorporated by reference in its entirety. The well conductor sections 168 can extend through a first seafloor section 169 and into a second deeper seafloor section 170 of the seafloor 101. The second seafloor section 170 can have a material density that is larger than a material density of the first seafloor section 169.

The well conductor sections 168 can be disposed at an object depth OD1 (shown in FIG. 4) below the seafloor 101 that is within a range of 100 feet to 150 feet. Using operations described herein, the system 100 can reliably detect the locations of buried objects across a variety of object depths and a variety of seafloor depths. For example, the system 100 can reliably determine the locations of buried objects that are buried at the object depth OD1, and the locations of other buried objects that are buried at object depths of less than 100 feet. The system 100 can also reliably determine the locations of buried objects that are buried at object depths of more than 150 feet.

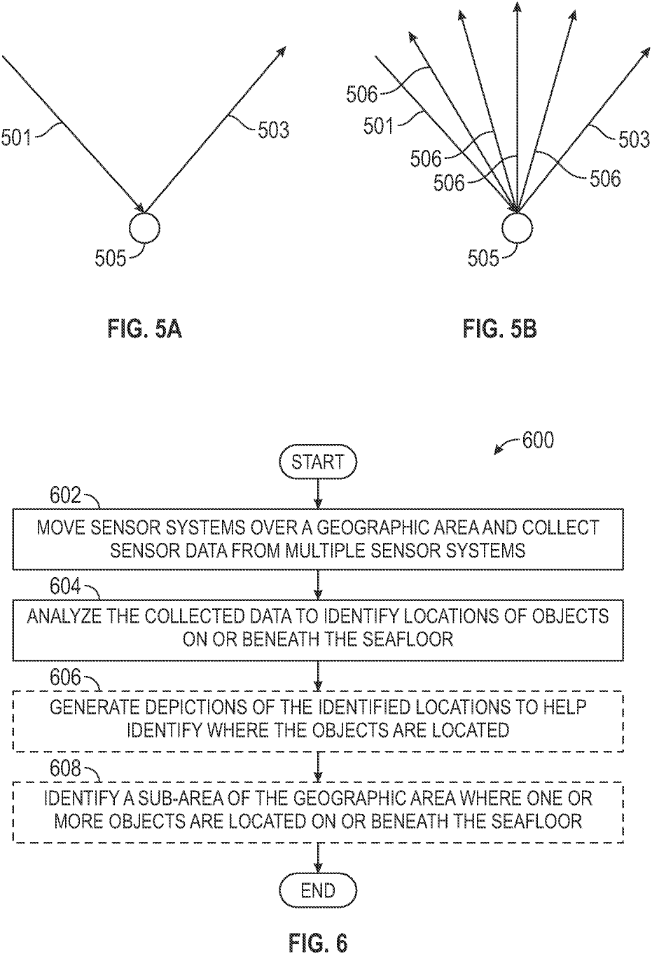

FIG. 5A shows specular reflection of seismic energy 501 from an object 505, such as a pipe. In FIG. 5A, emitted seismic energy 501 is reflected at a specular angle as specular reflected seismic energy 503 upon encountering the object 505. FIG. 5B shows seismic energy that includes diffracted seismic energy 506. In FIG. 5B, parts of the emitted seismic energy 501 diffracts (e.g., scatters) upon encountering the object 505. As discussed above in relation to FIG. 1, the seismic energy 115 that is collected using the seismic subsystem 110 includes both reflected and diffracted seismic energy 506.

FIG. 6 is a flow diagram of a method 600 of surveying a seafloor, according to an exemplary implementation. The method 600 begins and in step 602 multiple sensor systems are moved over a geographic area and data from the sensor systems is recorded. This can include operating two or more sensor systems simultaneously while the sensor systems are moved over the geographic area. Alternatively, one sensor system at a time can be operated while the sensor system is moved over the geographic area. If only one sensor system at a time is operated, step 602 would involve making multiple passes over the geographic area, where data is collected from one sensor system at a time during each pass over the geographic area.

The sensor systems could include a seismic sensor system that emits seismic energy toward the seafloor and that collects seismic data based on reflected and diffracted seismic energy that returns from the seafloor. The sensor systems could also include an acoustic sensor system that emits acoustic energy toward the seafloor and that collects acoustic data based on acoustic energy that returns from the seafloor. Further, the sensor systems could include an electrical sensor system that supplies electrical power into seawater and collects electric potential data of electric potential that is induced into the seawater.

In step 604 the data collected in step 602 is analyzed to identify locations of objects located on or beneath the seafloor. Step 604 can involve separately analyzing the data provided by each different sensor system, then looking for correlations between the data provided by the different sensor systems. In some instances, data from one or more of the sensor systems could be used to locate objects located at a first depth beneath the seafloor and data from one or more different sensor system or a different combination of sensor systems to identify the locations of objects located at a different depth beneath the seafloor

In step 606, which is an optional step, depictions of the identified locations of any objects are generated to help identify the locations. This could include two-dimensional depictions that identify the locations of objects on a map. Such two-dimensional depictions could include depth information to identify the depth at which an object is located. The depictions could also include three-dimensional depictions that show both location and depth. The depictions could be provided on a display screen or the depictions could be printed.

Step 608, which is also an optional step, involves identifying a sub-area of the geographical area where one or more objects are located. The sub-area identifies a location where excavation operations could be conducted to access objects located beneath the seafloor. The method 600 then ends.

It is contemplated that one or more of the aspects disclosed herein may be combined. As an example, it is contemplated that one or more of the aspects, features, operations, components, elements, and/or properties of the system 100 may be combined with one or more of the aspects, features, operations, components, elements, and/or properties of the two-dimensional image 300, the three-dimensional image 400, and/or the method 600. Moreover, it is contemplated that one or more of these aspects may include some or all of the benefits mentioned herein.

Conditional language, such as, “can,” “could,” “might,” or “may,” unless specifically stated otherwise, or otherwise understood within the context as used, is generally intended to convey that certain implementations could, but do not necessarily, include certain features and/or elements while other implementations may not. Thus, such conditional language generally is not intended to imply that features and/or elements are in any way required for one or more implementations or that one or more implementations necessarily include these features and/or elements. It is also intended that, unless expressly stated, the features and/or elements presented in certain implementations may be used in combination with other features and/or elements disclosed herein.

The specification and annexed drawings disclose example embodiments of the present disclosure. Detail features shown in the drawings may be enlarged herein to more clearly depict the features. Thus, the drawings are not necessarily precisely to scale. Additionally, the examples illustrate various features of the disclosure, but those of ordinary skill in the art will recognize that many further combinations and permutations of the disclosed features are possible. Accordingly, various modifications may be made to the disclosure without departing from the scope or spirit thereof. Further, other implementations and embodiments may be apparent from the specification and annexed drawings, and the practice of disclosed implementations and embodiments as presented herein. Examples disclosed in the specification and the annexed drawings should be considered, in all respects, as illustrative and not limiting. Although specific terms are employed herein, they are used in a generic and descriptive sense only, and are not intended to the limit the present disclosure. The present disclosure contemplates that one or more aspects of the implementations and embodiments described herein may be substituted in for, or used in addition to, other aspects described.

What is claimed is:

1. A method of surveying a seafloor, comprising:
moving survey equipment over a geographic area of the seafloor;
conducting a plurality of operations while moving the survey equipment over the geographic area to identify locations of one or more objects on or beneath the seafloor, the plurality of operations comprising two or more of:
a seismic operation that emits seismic energy toward the seafloor and collects seismic data based on reflected and/or diffracted seismic energy that returns from the seafloor,
an acoustic operation that emits acoustic energy toward the seafloor and collects acoustic data based on acoustic energy that returns from the seafloor, or
an electrical operation that supplies electrical power into seawater and collects electric potential data of electric potential that is induced into the seawater.

2. The method of claim 1, wherein the plurality of operations are conducted simultaneously with each other.

3. The method of claim 1, wherein the plurality of operations are conducted sequentially with respect to each other.

4. The method of claim 1, wherein the seismic data operation comprises emitting the seismic energy at frequencies of between approximately 300 Hz and approximately 1,200 Hz.

5. The method of claim 4, wherein the acoustic operation comprises emitting the acoustic energy at a frequency that is different from a frequency of the seismic energy emitted by the seismic operation.

6. The method of claim 1, wherein the seismic data of the seismic operation is collected in temporal sampling intervals of about 0.25 milliseconds and a slice duration of about 0.6 seconds.

7. The method of claim 1, wherein the seismic data collected by the seismic operation is based, at least in part, on diffracted seismic energy that returns from the seafloor.

8. The method of claim 1, wherein the survey equipment comprises:
a plurality of sparker units configured to be towed by a vessel, each sparker unit comprising a plurality of sparker electrodes configured to emit the seismic energy;
a plurality of seismic cables configured to be towed by a vessel; and
a plurality of seismic receivers disposed along each of the seismic cables and configured to detect seismic energy that returns from the seafloor.

9. The method of claim 8, wherein conducting a seismic operation comprises towing the sparker units and the seismic cables at a depth of approximately 5 meters or less relative to a surface of the seawater.

10. The method of claim 1, wherein the survey equipment comprises an acoustic transducer that is configured to emit the acoustic energy toward the seafloor and to detect acoustic energy that returns from the seafloor.

11. The method of claim 10, wherein the acoustic transducer is connected to a transceiver located above the seawater.

12. The method of claim 1, wherein conducting an electrical operation comprises pulsing electrical power into the seawater at a pulse interval of 0.5 seconds.

13. The method of claim 1, wherein the survey equipment comprises:
a plurality of transmitter electrodes configured to supply the electrical power into seawater; and
a plurality of receiver electrodes configured to detect electric potential in the seawater.

14. The method of claim 13, wherein conducting an electrical operation comprises moving the transmitter electrodes and the receiver electrodes over the geographic area at a height above the seafloor of approximately 10 meters or less.

15. The method of claim 14, wherein the height is approximately 5 meters.

16. The method of claim 13, wherein the transmitter electrodes are embedded respectively in a first electrode housing and a second electrode housing that are configured to be towed by a vessel, and the receiver electrodes are disposed along a receiver cable that is towed behind the second electrode housing.

17. The method of claim 1, further comprising processing two or more of the seismic data, the acoustic data, or the electric potential data to generate data points that indicate locations of one or more objects on or beneath the seafloor.

18. The method of claim 17, further comprising:
generating an image of the seafloor; and
plotting the data points in the image to identify locations of one or more objects on or beneath the seafloor.

19. The method of claim 18, further comprising identifying a subarea of the geographic area for accessing the one or more objects.

20. A system for determining locations of one or more objects located on or beneath a seafloor, comprising:
a memory; and
one or more processors configured to perform a method comprising:
receiving data from at least two of:
a seismic sensing system that emits seismic energy toward the seafloor and that collects seismic data based on reflected and/or diffracted seismic energy that returns from the seafloor,
an acoustic sensing system that emits acoustic energy toward the seafloor and that collects acoustic data based on acoustic energy that returns from the seafloor, and
an electrical sensing system that supplies electrical power into seawater and that collects electric potential data of electric potential that is induced into the seawater by the supplied electrical power;
analyzing the received data to determine the locations of one or more objects located on or beneath the seafloor.
